(19) United States
(12) Patent Application Publication
(10) Pub. No.: US 2011/0259369 A1
(43) Pub. Date: Oct. 27, 2011

(54) METHOD FOR CLEANING DEPOSITION CHAMBER

(75) Inventor: An-Ting Cheng, Tainan (TW)

(73) Assignee: AURIA SOLAR CO., LTD., Tainan (TW)

(21) Appl. No.: 13/177,088

(22) Filed: Jul. 6, 2011

(30) Foreign Application Priority Data
May 18, 2011 (TW) 100117386

(51) Int. Cl. B08B 3/00

(52) U.S. Cl. 134/21

(57) ABSTRACT

A method for cleaning a deposition chamber includes the following steps. A steam treatment is carried out on the deposition chamber to remove a contaminant in the deposition chamber by a steam. Then, a vacuum treatment is carried out on the deposition chamber to pump the steam containing the contaminant out of the deposition chamber. A time ratio of the steam treatment to the vacuum treatment is smaller than or equal to 0.65.

### CROSS-REFERENCE TO RELATED APPLICATIONS

This non-provisional application claims priority under 35 U.S.C. § 119(a) on Patent Application No. 100117386 filed in Taiwan (R.O.C) on May 18, 2011, the entire contents of which are hereby incorporated by reference.

### FIELD OF THE INVENTION

The present invention relates to a method for cleaning a semiconductor platform, and more particularly to a method for cleaning a deposition chamber.

### BACKGROUND OF THE INVENTION

The deposition process is a technique of forming a variety of materials that is widely applied in the semiconductor industry. The materials include a semiconductor material, an insulating material, a metal material, a metal alloy material, and the like.

However, in the course of deposition, the generated film is formed on a surface of a substrate upon which deposition is to be performed, and a contaminant may also be formed on an inner wall of a deposition chamber. If the contaminant is not completely removed, the substrate upon which deposition is to be performed will be polluted in the next deposition process.

When the substrate upon which deposition is to be performed is a glass substrate for fabricating solar cells, the aforementioned phenomenon will deteriorate the electrical property of the solar cells. For instance, referring to FIG. 1 and FIG. 2, FIG. 1 is a schematic view of a deposition chamber and a surface of a glass substrate with a trimethylboron (TMB) contaminant after a P layer is formed on the glass substrate in the prior art, and FIG. 2 is a schematic view of cleaning the deposition chamber by a plasma in the prior art. After a solar cell semi-finished product 100 is placed in the deposition chamber, a transparent conducting oxide (TCO) film 12 is formed on a glass substrate 11, and a P layer 13 is formed by vapor deposition, a TMB contaminant 131 will remain in the deposition chamber 200 and on a surface of the solar cell semi-finished product 100.

In the prior art, a hydrogen or carbon dioxide plasma P1 is introduced into the deposition chamber 200, and then a vacuum treatment is carried out to pump the plasma P1 out of the deposition chamber 200. In this manner, part of the TMB contaminant 131 may be removed. However, the TMB contaminant 131 cannot be completely removed, which causes the deterioration of the electrical property and the decrease of the production yield of the solar cells.

Therefore, a heretofore unaddressed need exists in the art to address the aforementioned deficiencies and inadequacies.

### SUMMARY OF THE INVENTION

In one aspect, the present invention is directed to a method for cleaning a deposition chamber, which can effectively remove a contaminant inside a deposition chamber.

In one embodiment, a method for cleaning a deposition chamber is provided, which includes the following steps. First, a steam treatment is carried out on the deposition chamber to remove a contaminant in the deposition chamber by a steam. Then, a vacuum treatment is carried out on the deposition chamber to pump the steam containing the contaminant out of the deposition chamber. A time ratio of the steam treatment to the vacuum treatment is smaller than or equal to 0.65.

According to an embodiment of the present invention, the method for cleaning a deposition chamber further includes repeating the steam treatment and the vacuum treatment, in which the number of times of repeating the steam treatment and the vacuum treatment is smaller than 5.

According to an embodiment of the present invention, in the method for cleaning a deposition chamber, the contaminant is for example a dopant.

According to an embodiment of the present invention, in the method for cleaning a deposition chamber, the dopant is for example boron or TMB.

According to an embodiment of the present invention, in the method for cleaning a deposition chamber, the contaminant is for example formed in a process of depositing a silicon thin film containing a dopant in the deposition chamber.

According to an embodiment of the present invention, in the method for cleaning a deposition chamber, a material of the silicon thin film is for example amorphous silicon.

According to an embodiment of the present invention, in the method for cleaning a deposition chamber, the contaminant is for example located on an inner wall of the deposition chamber or a substrate seat in the deposition chamber.

According to an embodiment of the present invention, in the method for cleaning a deposition chamber, a temperature of the steam is for example 180° C. to 220° C.

According to an embodiment of the present invention, in the method for cleaning a deposition chamber, a pumping rate of the vacuum treatment is for example 5000 m³/h to 7000 m³/h.

The present invention, among other things, has the following efficacy as compared with the prior art.

Based on the above description, in the method for cleaning a deposition chamber of the present invention, the time ratio of the steam treatment to the vacuum treatment is smaller than or equal to 0.65, thus effectively cleaning the deposition chamber to remove the contaminant inside the deposition chamber.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 is a schematic view of a deposition chamber and a surface of a glass substrate with a TMB contaminant after a P layer is formed on the glass substrate in the prior art;

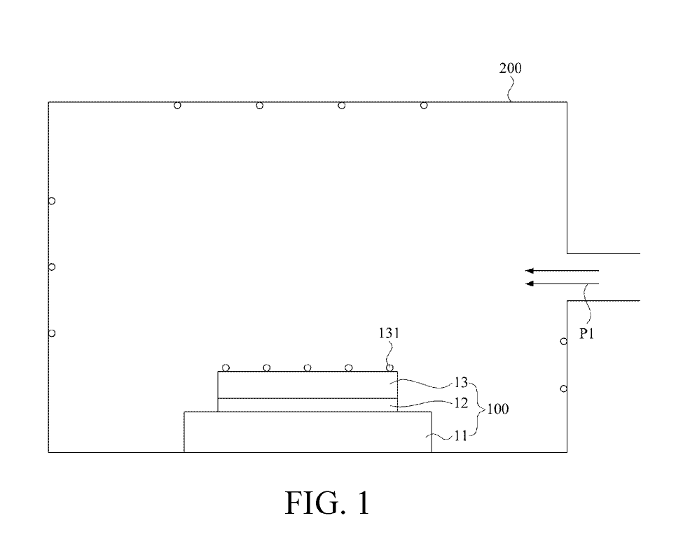

FIG. 2 is a schematic view of cleaning the deposition chamber by a plasma in the prior art;

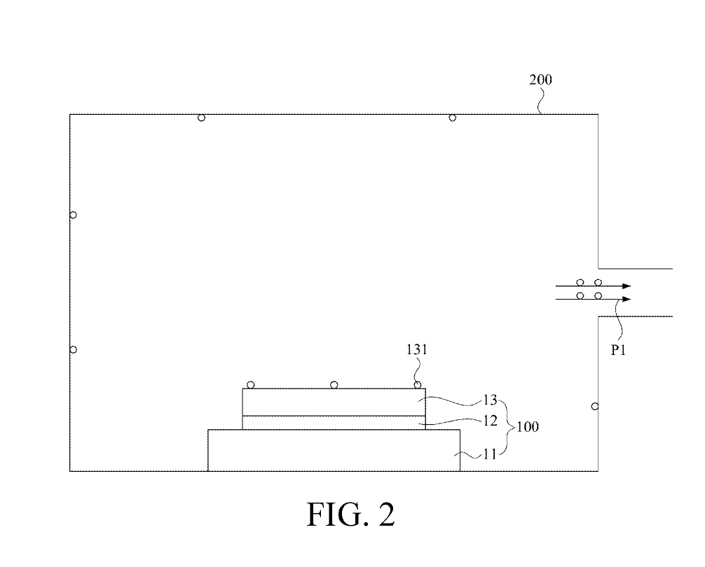

FIG. 3 is a schematic view of a deposition chamber and a surface of a glass substrate with a TMB contaminant after a P layer is formed on the glass substrate; and

FIG. 4 is a schematic view of cleaning the deposition chamber by a steam according to one embodiment of the present invention.

### DETAILED DESCRIPTION OF THE INVENTION

The present invention relates to a method for cleaning a semiconductor platform, and more particularly to a method for cleaning a deposition chamber. Hereinafter, a preferred embodiment of the present invention is described and those skilled in the art should understand that the embodiment is exemplary and is not intended to limit the present invention. The details of the preferred embodiment are described as follows.

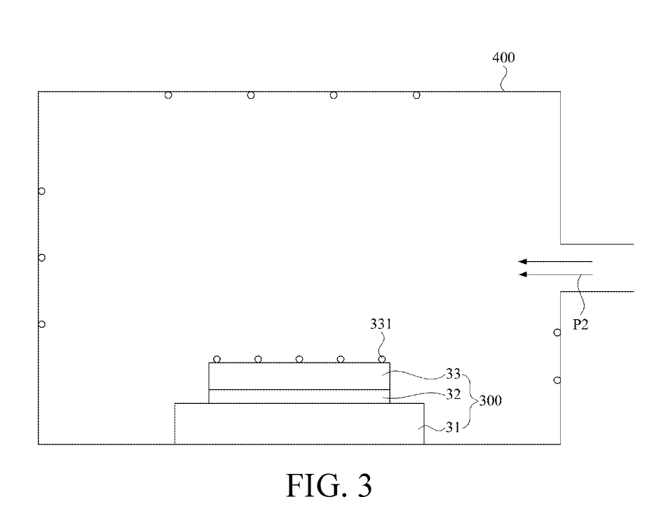

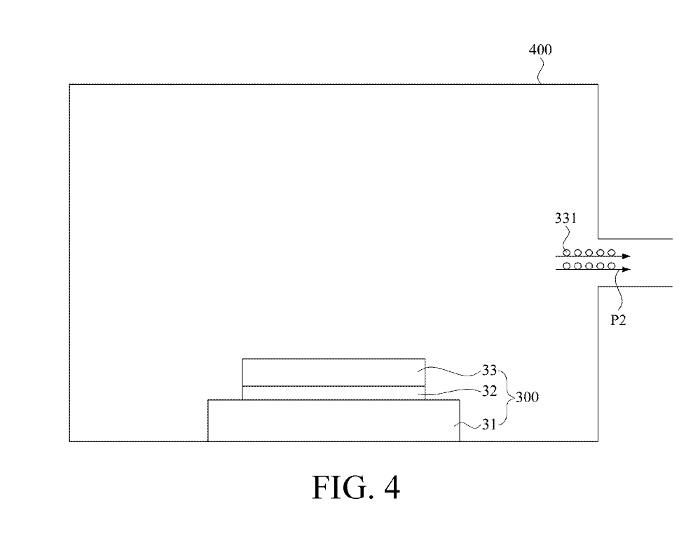

Referring to FIG. 3 and FIG. 4, FIG. 3 is a schematic view of a deposition chamber and a surface of a glass substrate with a TMB contaminant after a P layer is formed on the glass substrate, and FIG. 4 is a schematic view of cleaning the deposition chamber by a steam.

First, a steam treatment is carried out on a deposition chamber 400 by introducing a steam P2 into the deposition chamber 400. A temperature of the steam is for example 180° C. to 220° C. and preferably is 200° C. Moreover, the contaminant 331 is for example located on an inner wall of the deposition chamber 400, which is not intended to limit the present invention. For example, in the embodiment of FIG. 3 and FIG. 4, a solar cell semi-finished product 300 may be placed in the deposition chamber 400 and the solar cell semi-finished product 300 includes a glass substrate 31, a TCO film 32, and a P layer 33 formed by vapor deposition. The contaminant 331 is for example located on the inner wall of the deposition chamber 400, a substrate seat, and the solar cell semi-finished product 300 at the same time. The contaminant 331 inside the deposition chamber 400 is for example a dopant, e.g., boron or TMB. The deposition chamber 400 is for example a reaction chamber of a chemical vapor deposition platform or a reaction chamber of a physical vapor deposition platform.

In one embodiment, the contaminant 331 is for example formed in the process of depositing a silicon thin film containing a dopant in the deposition chamber 400. The contaminant 331 is for example the silicon thin film containing the dopant and is usually formed on the inner wall of the deposition chamber 400 and the substrate seat. A material of the silicon thin film is for example amorphous silicon and the dopant is for example boron or TMB.

Then, a vacuum treatment is carried out on the deposition chamber 400 to pump the steam P2 containing the contaminant 331 out of the deposition chamber 400. Since the steam P2 can wrap the contaminant 331 containing TMB more completely as compared with the hydrogen or nitrogen dioxide plasma, the present invention provides a better cleaning effect as compared with the method for cleaning the deposition chamber in the prior art. A time ratio of the steam treatment to the vacuum treatment is smaller than or equal to 0.65, thus maintaining the amount of the steam in the deposition chamber 400 to obtain a better cleaning effect. A pumping rate of the vacuum treatment is for example 5000 m³/h to 7000 m³/h and preferably is 6000 m³/h.

Furthermore, the method for cleaning the deposition chamber 400 may further include repeating the steam treatment and the vacuum treatment. The number of times of repeating the steam treatment and the vacuum treatment is smaller than 5, so as to effectively clean the deposition chamber 400 and further completely remove the contaminant 331 inside the deposition chamber 400.

Based on the above embodiment, since the steam P2 can wrap the contaminant 331 containing TMB more completely as compared with the hydrogen or nitrogen dioxide plasma, and the time ratio of the steam treatment to the vacuum treatment is smaller than or equal to 0.65, which enhances the cleaning effect, the present invention can clean the deposition chamber 400 in a more effective way to remove the contaminant 331 inside the deposition chamber 400, thereby improving the film quality of the deposition platform.

In summary, the method for cleaning a deposition chamber in the above embodiment, among other things, at least has the following advantages.

1. The method for cleaning a deposition chamber in the above embodiment may effectively remove the contaminant inside the deposition chamber.

2. The method for cleaning a deposition chamber in the above embodiment may improve the film quality of the deposition platform.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A method for cleaning a deposition chamber, comprising:
a. carrying out a steam treatment on the deposition chamber to remove a contaminant inside the deposition chamber by a steam; and
b. carrying out a vacuum treatment on the deposition chamber to pump the steam containing the contaminant out of the deposition chamber, wherein a time ratio of the steam treatment to the vacuum treatment is smaller than or equal to 0.65.

2. The method for cleaning a deposition chamber according to claim 1, further comprising repeating the steam treatment and the vacuum treatment, wherein a number of times of repeating the steam treatment and the vacuum treatment is smaller than 5.

3. The method for cleaning a deposition chamber according to claim 1, wherein the contaminant comprises a dopant.

4. The method for cleaning a deposition chamber according to claim 3, wherein the dopant comprise boron or trimethylboron (TMB).

5. The method for cleaning a deposition chamber according to claim 1, wherein the contaminant is formed in a process of depositing a silicon thin film containing a dopant in the deposition chamber.

6. The method for cleaning a deposition chamber according to claim 5, wherein a material of the silicon thin film comprises amorphous silicon.

7. The method for cleaning a deposition chamber according to claim 1, wherein the contaminant is located on an inner wall of the deposition chamber or a substrate seat in the deposition chamber.

8. The method for cleaning a deposition chamber according to claim 1, wherein a temperature of the steam is 180° C. to 220° C.

9. The method for cleaning a deposition chamber according to claim 1, wherein a pumping rate of the vacuum treatment is 5000 m³/h to 7000 m³/h.
